(19) United States
(12) Patent Application Publication
(10) Pub. No.: US 2018/0002135 A1
(43) Pub. Date: Jan. 4, 2018

(54) SEPARATOR CORE AND SEPARATOR ROLL

(71) Applicant: Sumitomo Chemical Company, Limited, Tokyo (JP)

(72) Inventors: Yosuke TSUKUDA, Niihama-shi (JP); Daizaburo YASHIKI, Niihama-shi (JP)

(21) Appl. No.: 15/637,319

(22) Filed: Jun. 29, 2017

(30) Foreign Application Priority Data
Jun. 30, 2016 (JP) 2016-003129

(51) Int. Cl. B65H 75/10; H01M 2/14; H01M 2/16; H01M 2/18; H01M 8/0289

(52) U.S. Cl. CPC B65H 75/10; H01M 2/1653; H01M 2/18; H01M 2/145; H01M 8/0289; H01M 2/1686

(57) ABSTRACT

The present invention efficiently avoids distortion at an edge and achieves a separator core which has strength. The present invention achieves: a separator core in which an outer cylindrical part has a linearly inclined face at an edge of an outer peripheral surface thereof; and a separator roll including the separator core and a separator for a nonaqueous electrolyte secondary battery wound around the separator core. The present invention provides a method of producing the separator roll.

This Nonprovisional application claims priority under 35 U.S.C. §119(a) on Utility Model Application No. 2016-003129 filed in Japan on Jun. 30, 2016, the entire contents of which are hereby incorporated by reference.

### TECHNICAL FIELD

The present invention relates to a separator core around which a separator for a nonaqueous electrolyte secondary battery is wound or is to be wound and a separator roll obtained by winding a separator for a nonaqueous electrolyte secondary battery around a separator core.

### BACKGROUND ART

Patent Literature 1 discloses an example of the shape of a separator core (hereinafter may be referred to as the “core”). When a separator is transported by a transport system such as a roller and continuously produced, the resulting separator is wound around this separator core to be supplied as a product.

The core disclosed in Patent Literature 1 has an outer cylindrical part around which a separator is wound, an inner cylindrical part which serves as a bearing for a shaft, and support parts which are connected to the outer cylindrical part and the inner cylindrical part (such support parts may be hereinafter referred to as “ribs”). The produced separator is supplied in the form of a roll, which is obtained by winding the separator around the outer cylindrical part.

### CITATION LIST

### Patent Literature

[Patent Literature 1]
Japanese Patent Application Publication, Tokukai No. 2013-139340 (Publication date: Jul. 18, 2013)

### SUMMARY OF INVENTION

### Technical Problem

By the way, a core like that described above is often produced by processing a resin by injection molding, where the resin (a raw material) is injected into a mold. In the injection molding, the resin injected in the mold flows slowly in the edge portions of the mold (corresponding to the edges of the core), and molecular orientation of the resin in the edge portions is distorted. Therefore, the resulting core may have residual stress.

The core which has residual stress, like that described above, has reduced strength, and therefore the core may deform greatly when a separator is wound around the core. If the separator wound around the deformed core remains in this state for a long period of time, the separator may deform, which may result in a reduction in quality.

The present invention was made in view of the above problem, and it is an object of the present invention to achieve a separator core that has no or little distortion in edge portions and that has strength.

### Solution to Problem

In order to attain the above object, a separator core in accordance with an aspect of the present invention is a separator core around which a separator for a nonaqueous electrolyte secondary battery is wound or is to be wound, including: an outer cylindrical part; an inner cylindrical part provided inside the outer cylindrical part; and support parts that are provided between the outer cylindrical part and the inner cylindrical part and that extend in radial directions to connect to the outer cylindrical part and the inner cylindrical part, the outer cylindrical part having a linearly inclined face at an edge of an outer peripheral surface thereof.

### Advantageous Effects of Invention

According to each aspect of the present invention, there is no or little distortion in resin at an edge. Therefore, it is possible to provide a separator core that has great strength and that causes no or little deformation of a separator and a separator roll that provides a separator for a nonaqueous electrolyte secondary battery wound around the separator core.

### BRIEF DESCRIPTION OF DRAWINGS

FIG. 1 schematically illustrates a cross sectional configuration of a lithium-ion secondary battery.

FIG. 2 schematically illustrates states of the lithium-ion secondary battery illustrated in FIG. 1

FIG. 3 schematically illustrates states of a lithium-ion secondary battery having another configuration.

FIG. 4 schematically illustrates a configuration of a slitting apparatus for slitting a separator.

FIG. 5 shows a front view of a separator core in accordance with an embodiment of the present invention and a front view of a separator roll obtained by winding a separator around a separator core in accordance with an embodiment of the present invention.

FIG. 6 is a cross-sectional view of a separator core in accordance with an embodiment of the present invention.

FIG. 7 is an enlarged view of an outer peripheral surface of an outer cylindrical part of a separator core of a separator roll in accordance with an embodiment of the present invention.

### DESCRIPTION OF EMBODIMENTS

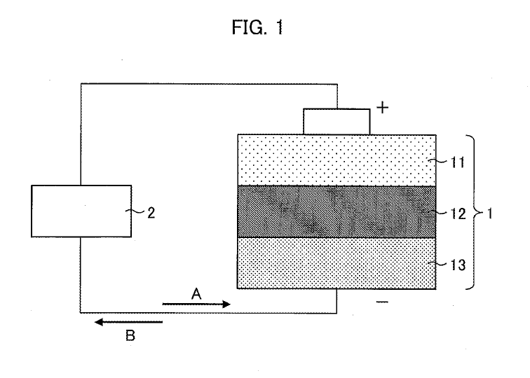

The following describes embodiments of the present invention in detail with reference to FIGS. 1 to 7. In the following description, a heat-resistant separator for a battery such as a lithium-ion secondary battery is used as an example of a separator for a nonaqueous electrolyte secondary battery wound around a separator core (core) in accordance with an embodiment of the present invention.

### <Configuration of Lithium-Ion Secondary Battery>

First, the following describes a lithium-ion secondary battery with reference to FIGS. 1 to 3.

A nonaqueous electrolyte secondary battery, typified by a lithium-ion secondary battery, has a high energy density, and therefore is currently and widely used as (i) batteries for use in devices such as personal computers, mobile phones, and mobile information terminals, and moving bodies such as automobiles and airplanes, and (ii) stationary batteries contributing to stable power supply.

FIG. 1 schematically illustrates a cross sectional configuration of a lithium-ion secondary battery 1.

As illustrated in FIG. 1, the lithium-ion secondary battery 1 includes a cathode 11, a separator 12, and an anode 13. Outside the lithium-ion secondary battery 1, an external device 2 is connected to the cathode 11 and the anode 13. Electrons move in a direction A while the lithium-ion secondary battery 1 is being charged, and the electrons move in a direction B while the lithium-ion secondary battery 1 is being discharged.

<Separator>

The separator 12 is provided so as to be sandwiched between (i) the cathode 11 which is a positive electrode of the lithium-ion secondary battery 1 and (ii) the anode 13 which is a negative electrode of the lithium-ion secondary battery 1. The separator 12 allows lithium ions to move between the cathode 11 and the anode 13 while the separator 12 separates the cathode 11 from the anode 13. The separator 12 is made of, for example, a polyolefin such as polyethylene or polypropylene.

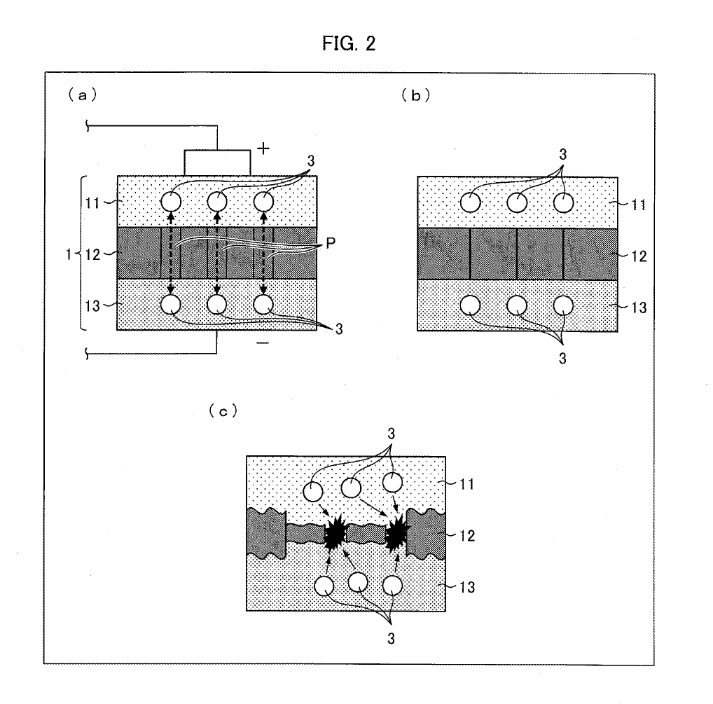

FIG. 2 schematically illustrates states of the lithium-ion secondary battery 1 illustrated in FIG. 1. (a) of FIG. 2 illustrates a normal state. (b) of FIG. 2 illustrates a state in which the temperature of the lithium-ion secondary battery 1 has risen. (c) of FIG. 2 illustrates a state in which the temperature of the lithium-ion secondary battery 1 has sharply risen.

As illustrated in (a) of FIG. 2, the separator 12 has many pores P. Normally, lithium ions 3 can move back and forth in the lithium-ion secondary battery 1 through the pores P.

The temperature of the lithium-ion secondary battery 1 may rise due to, for example, excessive charging of the lithium-ion secondary battery 1 or a high current caused by short-circuiting of an external device. This causes the separator 12 to be melt or soften, so that the pores P are blocked as illustrated in (b) of FIG. 2. As a result, the separator 12 shrinks. This causes the lithium ions 3 to stop moving back and forth, and ultimately causes the temperature of the lithium-ion secondary battery 1 to stop rising.

Note, however, that in a case where the temperature of the lithium-ion secondary battery 1 sharply rises, the separator 12 suddenly shrinks. In this case, the separator 12 may be destroyed (see (c) of FIG. 2). This causes the lithium ions 3 to leak out from the separator 12 which has been destroyed. As a result, the lithium ions 3 will never stop moving back and forth. Consequently, the temperature of the lithium-ion secondary battery 1 continues to rise.

<Heat-Resistant Separator>

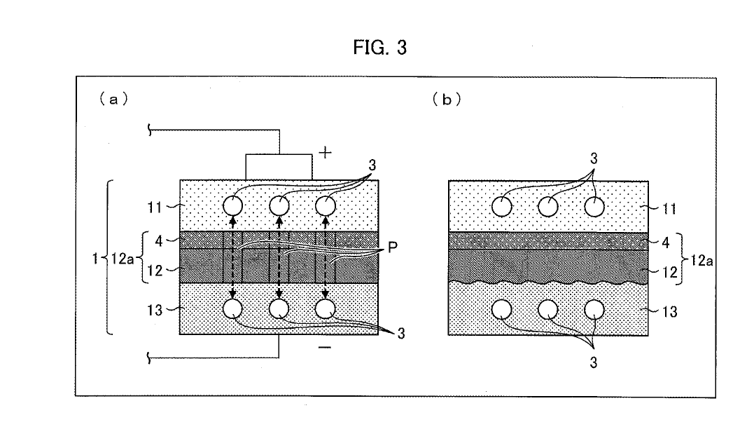

FIG. 3 schematically illustrates states of a lithium-ion secondary battery 1 having another configuration. (a) of FIG. 3 illustrates a normal state, and (b) of FIG. 3 illustrates a state in which the temperature of the lithium-ion secondary battery 1 has sharply risen.

As illustrated in (a) of FIG. 3, the lithium-ion secondary battery 1 may further include a heat-resistant layer 4. This heat-resistant layer 4 may be provided on the separator 12. (a) of FIG. 3 illustrates a configuration in which the separator 12 is provided with the heat-resistant layer 4 serving as a functional layer. Hereinafter, a film in which the separator 12 is provided with the heat-resistant layer 4 is referred to as a heat-resistant separator 12a, which is an example of a functional layer-attached separator. The separator 12 of the functional layer-attached separator is a base material whereas the heat-resistant layer 4 is the functional layer.

According to the configuration illustrated in (a) of FIG. 3, the heat-resistant layer 4 is stacked on a surface of the separator 12 which surface faces the cathode 11. Note that the heat-resistant layer 4 can be alternatively stacked (i) on a surface of the separator 12 which surface faces the anode 13 or (ii) on the both surfaces of the separator 12. The heat-resistant layer 4 has pores which are similar to pores P. Normally, lithium ions 3 move back and forth through the pores P and the pores of the heat-resistant layer 4. Materials of the heat-resistant layer 4 include, for example, wholly aromatic polyamide (aramid resin).

Even in a case where the separator 12 melts or softens due to a sharp rise in temperature of the lithium-ion secondary battery 1, the shape of the separator 12 is maintained (see (b) of FIG. 3) because the heat-resistant layer 4 supports the separator 12. This causes the separator 12 to come off with melting or softening, so that the pores P only blocks up. This causes the lithium ions 3 to stop moving back and forth, and ultimately causes the above-described excessive discharging or excessive charging to stop. In this way, the separator 12 is prevented from being destroyed.

<Production Steps for Separator and Heat-Resistant Separator>

How to produce the separator and the heat-resistant separator of the lithium-ion secondary battery 1 is not specifically limited. The separator and the heat-resistant separator can be produced by a publicly known method. The following discussion assumes a case where a porous film from which the separator (heat-resistant separator) is made contains polyethylene as a main material. Note, however, that even in a case where the porous film contains another material, the separator (heat-resistant separator) can be produced by a similar production method.

Examples of such a similar production method encompass a method which includes the steps of forming a film by adding inorganic filler or a plasticizer to a thermoplastic resin, and then removing the inorganic filler or the plasticizer with an appropriate solvent. For example, in a case where the porous film is a polyolefin separator made of a polyethylene resin containing ultra-high molecular weight polyethylene, the porous film can be produced by the following method.

This method includes (1) a kneading step of kneading a ultra-high molecular weight polyethylene with (i) an inorganic filler (such as calcium carbonate or silica) or (ii) a plasticizer (such as low molecular weight polyolefin or fluid paraffin) to obtain a polyethylene resin composition, (2) a rolling step of rolling the polyethylene resin composition to form a film thereof, (3) a removal step of removing the inorganic filler or the plasticizer from the film obtained in the step (2), and (4) a stretching step of stretching the film obtained in the step (3) to obtain the porous film. The step (4) can be alternatively carried out between the steps (2) and (3).

In the removal step, many fine pores are formed in the film. The fine pores of the film stretched in the stretching step serve as the above-described pores P. The porous film (separator 12) is thus obtained. Note that the porous film is a polyethylene microporous film having a prescribed thickness and a prescribed air permeability.

Note that, in the kneading step, (i) 100 parts by weight of the ultra-high molecular weight polyethylene, (ii) 5 parts by weight to 200 parts by weight of a low molecular weight polyolefin having a weight-average molecular weight of 10000 or less, and (iii) 100 parts by weight to 400 parts by weight of the inorganic filler can be kneaded.

Thereafter, in a coating step, the heat-resistant layer 4 is formed on a surface of the porous film. For example, by applying, onto the porous film, an aramid/NMP (N-methyl-pyrrolidone) solution (coating solution), the heat-resistant layer 4 that is an aramid heat-resistant layer is formed. The heat-resistant layer 4 may be provided on a single surface or both surfaces of the porous film. Alternatively, the heat-resistant layer 4 may be formed with a coating using a mixed solution containing a filler such as alumina/carboxymethyl cellulose.

Note that, in the coating step, an adhesive layer can be formed on a surface of the porous film, by applying a polyvinylidene fluoride/dimethyl acetamide solution (coating solution) on the porous film (application step) and allowing the coating solution to deposit (depositing step). The adhesive layer may be formed on the single surface of the porous film or on the both surfaces of the porous film.

A method of coating the porous film with a coating solution is not specifically limited, provided that uniform wet coating can be carried out by the method. As the method employed is a conventionally publicly known method such as a capillary coating method, a spin coating method, a slit die coating method, a spray coating method, a dip coating method, a roll coating method, a screen printing method, a flexo printing method, a bar coater method, a gravure coater method, or a die coater method. The heat-resistant layer 4 has a thickness which can be controlled by adjusting a thickness of a coating wet film or a solid-content concentration in the coating solution.

The porous film containing a polyolefin as a base material, which is to be coated, is fixed to or transferred with a support. As the support used is a resin film, a metal belt, a drum or the like.

The separator 12 (heat-resistant separator) can thus be produced in which the heat-resistant layer 4 is stacked on the porous film. The separator thus produced is wound around a core having a cylindrical shape. Note that a subject to be produced by the above production method is not limited to the heat-resistant separator. The above production method does not necessarily include the coating step. In a case where no coating step is included in the production method, the subject to be produced is a separator including no heat-resistant layer.

<Slitting Apparatus>

The heat-resistant separator or the separator including no heat-resistant layer (hereinafter, referred to as “separator”) preferably has a width (hereinafter, referred to as “product width”) suitable for application products such as the lithium-ion secondary battery 1. Note, however, that the separator is produced so as to have a width that is equal to or larger than a product width, in view of an improvement in productivity. After the separator is once produced, the separator is cut (slit) into a separator(s) having the product width.

Note that the “width of the separator” means a dimension of the separator (i) in parallel with a plane along which the separator extends and (ii) in a direction perpendicular to a lengthwise direction of the separator. Hereinafter, a wide separator which has not been slit is referred to as an “original sheet,” whereas particularly a separator which has been slit is referred to as a “slit separator.” Note also that (i) “slitting” means to cut the separator in the lengthwise direction (a direction in which a film flows during production; MD: Machine direction) and (ii) “cutting” means to cut the separator in a transverse direction (TD). Note that the transverse direction (TD) means a direction which is (i) parallel to the plane along which the separator extends and (ii) substantially perpendicular to the machine direction (MD) of the separator.

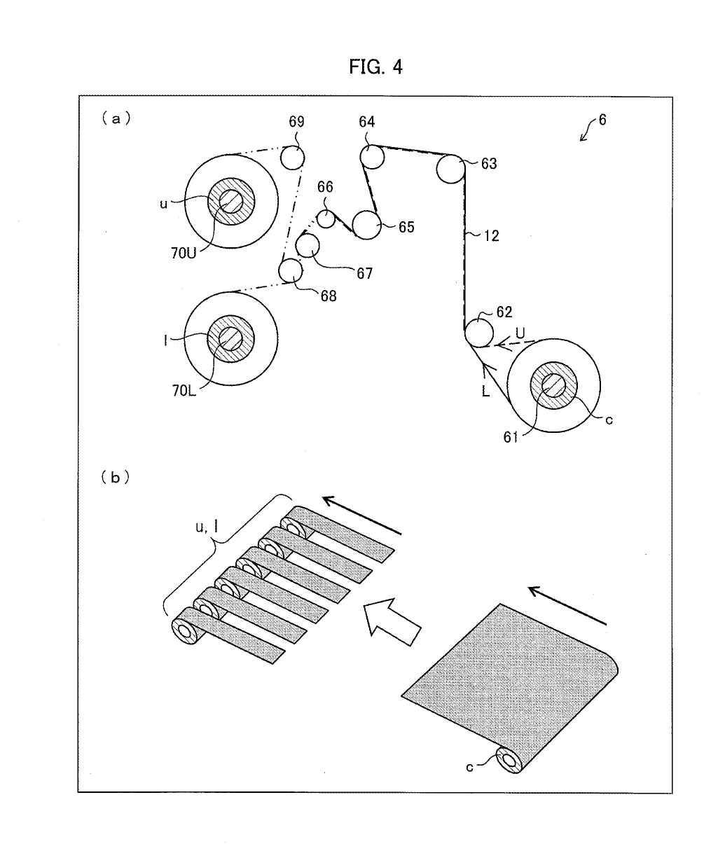

FIG. 4 schematically illustrates a configuration of a slitting apparatus 6 for slitting the separator. (a) of FIG. 4 illustrates an entire configuration, and (b) of FIG. 4 illustrates arrangements before and after slitting the original sheet.

As illustrated in (a) of FIG. 4, the slitting apparatus 6 includes a rotatably-supported cylindrical wind-off roller 61, rollers 62 through 69, and take-up rollers 70U and 70L.

(Before Slitting)

In the slitting apparatus 6, a cylindrical core c around which the original sheet is wrapped is fitted on the wind-off roller 61. As illustrated in (b) of FIG. 4, the original sheet is wound off from the core c to a route U or L. The original sheet which has been thus wound off is transferred to the roller 68 via the rollers 63 through 67. While the original sheet is being transferred, the original sheet is slit into a plurality of slit separators. Note that the number and arrangement of the rollers 62 through 69 can be changed in order to transfer the original sheet in a desired pathway.

(After Slitting)

As illustrated in (b) of FIG. 4, some of the plurality of slit separators are wound around respective cylindrical cores u (separator cores) which are fitted on the take-up roller 70U. Meanwhile, the others of the plurality of slit separators are wound around respective cylindrical cores 1 (separator cores), which are fitted on the take-up roller 70L. Note that (i) the slit separators each wound around in a roll manner and (ii) the respective cores u and 1 are, as a whole, referred to as a “roll (separator roll)”.

The present invention relates to a core (separator core) around which a separator for a nonaqueous electrolyte secondary battery, such as the above-described slit separator, is wound or is to be wound and a separator roll obtained by winding a separator for a nonaqueous electrolyte secondary battery around the core.

<Separator Core and Separator Roll>

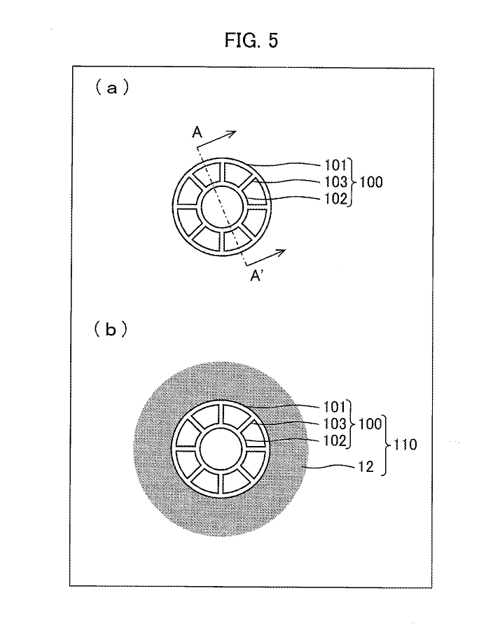

The following describes a separator core of an embodiment of the present invention with reference to FIGS. 5 to 7.

FIG. 5 shows a front view of a core and a front view of a separator roll in which a separator is wound around a core.

The shaft of a take-up roller or the like is fitted in the inner cylindrical part 102 of the core 100 illustrated in (a) of FIG. 5 and, while the core 100 is rotated, the separator 12 is wound around the outer cylindrical part 101 with constant tension, such that a separator roll 110 illustrated in (b) of FIG. 5 is produced.

The above-described core 100 can be used as, for example, the core u or 1 of the slitting apparatus 6 illustrated in FIG. 4. That is, the separator 12 can be wound around the core 100 in a winding step similar to that described earlier.

<Structure of Core>

The core 100 illustrated in (a) of FIG. 5 includes an outer cylindrical part 101, an inner cylindrical part 102, and ribs 103. The outer cylindrical part 101 defines the outer peripheral surface of the core 100 on which the separator 12 is wound. The inner cylindrical part 102 is provided inside the outer cylindrical part 101 and serves as a bearing in which a shaft of, for example, a take-up roller for rotating the core is fitted. The ribs 103 are support parts provided between the outer cylindrical part 101 and the inner cylindrical part 102 so as to extend in radial directions and connect to the outer cylindrical part 101 and the inner cylindrical part 102.

In the present embodiment, the ribs 103 are equally spaced at eight locations around the circumference and perpendicular to the outer cylindrical part 101 and the inner cylindrical part 102. However, the number of ribs, the spaces between the ribs, and the like are not limited to such.

Furthermore, although the central axes of the outer cylindrical part 101 and the inner cylindrical part 102 preferably substantially coincide with each other, this does not imply any limitation. Furthermore, dimensions such as the thicknesses of the outer cylindrical part 101 and the inner cylindrical part 102, the width of the outer peripheral surface, and the radius of each cylindrical part may be determined appropriately depending on types of separator for a nonaqueous electrolyte secondary battery to be produced.

Materials that can be suitably used to make the core 100 are resins containing an ABS resin, a polyethylene resin, a polypropylene resin, a polystyrene resin, a polyester resin, and/or a vinyl chloride resin. It is possible to produce the core 100 from any of these resins by resin molding using a mold.

<45° Inclined Face>

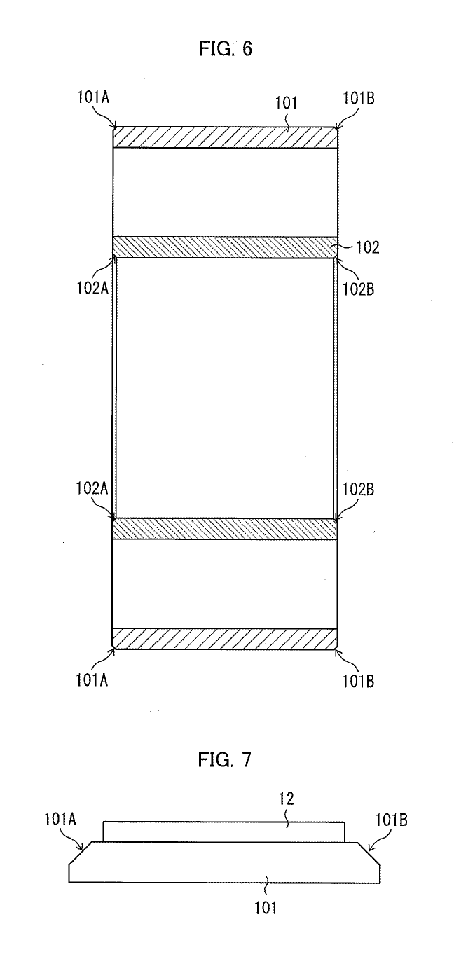

FIG. 6 is a cross-sectional view taken along A-A′ of the core 100 illustrated in (a) of FIG. 5.

As illustrated in FIG. 6, the outer cylindrical part 101 has 45° inclined faces at edges 101A and 101B of the outer peripheral surface thereof. Furthermore, as with the edges 101A and 101B of the outer peripheral surface of the outer cylindrical part 101, the inner cylindrical part 102 also has 45° inclined faces at edges 102A and 102B of the inner peripheral surface thereof.

In this description, a 45°±5° inclined face is referred to as a chamfer. That is, the 45° inclined face as described above is a kind of chamfer. In view of more efficiently obtaining a core that has no or little distortion at its edge, it is preferable that the chamfer be at an angle of 45°±2°, more preferably 45°±1°.

The chamfer means a surface at an angle of 45°±5° with respect to two adjoining surfaces of a workpiece. In a case where the un-chamfered intersection of the adjoining surfaces would otherwise form substantially a right angle like, for example, the edges 101A and 101B of the outer cylindrical part 101, the chamfer is a face that passes through the following two positions: a position on one of the two adjoining surfaces at a certain distance from the intersection; and a position on the other of the two adjoining surfaces at the same distance from the intersection.

Since the core 100 has inclined faces at the edges 101A, 101B, 102A, and 102B in this manner, the core 100 has no or little residual distortion, which may result from injection molding.

Furthermore, since the core 100 has inclined faces at the edges 102A and 102B of the inner cylindrical part 102, the shaft of a take-up roller or the like is readily fitted in the inner cylindrical part 102.

The inclined faces at the edges may be formed by, for example: a method by which a workpiece having a sharp edge is molded (injection molded) and thereafter the sharp edge is removed; or a method by which a workpiece is molded (injection molded) with the use of a mold having inclined faces at edges. In the former case, if a resin entrance (gate) for injection molding is located at a portion that is to be removed to form an inclined face, the mark from the gate can be removed when the portion is removed. In the latter case, the resin flows inside the mold fluently and thus the resulting molded body (part) will have no or little distortion.

<Chamfer of Outer Cylindrical Part>

FIG. 7 is an enlarged cross-sectional view of an outer cylindrical part of a separator core of a separator roll. It should be noted that, for convenience of description, the other members of the separator roll 110 are not illustrated.

FIG. 7 is an enlarged cross-sectional view of the outer cylindrical part 101 of the separator roll 110.

The separator 12 is wound on the outer peripheral surface of the outer cylindrical part 101 of the core 100. Note, here, that the separator 12 is not wound on the chamfer of the outer peripheral surface of the outer cylindrical part 101. By winding the separator 12 in a manner such that the separator 12 does not overlap the chamfer like above, it is possible to prevent the breakage and deformation of the separator 12.

To this end, it is necessary that, on the outer peripheral surface of the outer cylindrical part 101 around which the separator 12 is wound, the width of the un-chamfered portion be larger than the width of the separator 12. With this arrangement, it is possible to wind the separator 12 so that the separator 12 does not overlap the chamfer of the outer peripheral surface of the outer cylindrical part 101 by winding the separator 12 in a manner such that the center of the width of the separator 12 substantially coincides with the center of the width of the outer peripheral surface of the outer cylindrical part 101.

For such a core 100 to be produced, the width of the outer cylindrical part 101 is determined in consideration of the width of the separator 12 and the distance of the chamfer when the core 100 is to be injection molded.

In a case where the chamfer is created in an attempt to obtain a core 100 that contains no or little resin with distortion, it is preferable that the distance of the chamfer be at least 0.3 mm. Such a distance of the chamber makes it possible to obtain a core 100 that contains no or little resin with distortion.

Furthermore, the distance of the chamfer, which represents the distance from the un-chamfered edge that would otherwise be present if the chamfer was not created to the position at which the chamfer starts, is preferably 2.5 mm or less, more preferably 1 mm or less. With such a distance, the outer peripheral surface of the outer cylindrical part 101, on which the separator 12 is wound, has a large-enough un-chamfered area. Therefore, it is possible to efficiently prevent the separator 12 from being wound on the chamfer of the outer cylindrical part 101.

Note here that, in a case where the edge is rounded to have a curved face and thereby resin at the edge is removed, the rounding has to be about 1.5 times larger than the chamfering, provided that the volume of the resin to be removed is substantially the same.

Therefore, as compared to the rounding, the chamfering makes it possible to achieve the outer cylindrical part 101 that has a smaller width, because the un-chamfered area of the outer peripheral surface of such an outer cylindrical part 101 is large enough for the separator 12 to be wound in a manner such that the separator 12 does not overlap the chamfer.

Since the width of the outer cylindrical part 101 can be reduced, it is possible to achieve weight reduction and cost reduction of the core 100 and the separator roll 110.

Furthermore, also the inner peripheral surface of the inner cylindrical part 102 is preferably chamfered rather than rounded. This is because a shaft is more easily fitted in the inner cylindrical part 102 when the inner cylindrical part 102 has a 45°±5° inclined face at an edge than when the inner cylindrical part 102 has a curved face at the edge.

In addition to the above-described portions, other portions such as the inner peripheral surface of the outer cylindrical part 101, the outer peripheral surface of the inner cylindrical part 102, and/or the ribs 103 may also have their edges removed, if needed. The edges may be chamfered in the same manner as above, or may be removed by any of, for example, rounding, light-chamfering, or the like.

In a case where the outer cylindrical part 101, the inner cylindrical part 102, and/or the ribs 103 are chamfered as described above, the distance of the chamfer is preferably equal to or less than one third the thickness of each part. Such a distance makes it possible to significantly reduce the risks of breakage and chipping.

It should be noted that, although the core 100 which is chamfered at the edges 101A, 101B, 102A, and 102B is discussed as an example in the above description, the angle of the inclined face at each edge is not limited to 45°, provided that the core 100 of the present embodiment has a linearly inclined face(s) at the edges 101A, 101B, 102A, and/or 102B.

<Recap>

A core 100, which is chamfered as described above, contains no or little resin with distortion and thus has great strength and is resistant to deformation. Therefore, a separator roll 110, in which a separator 12 is wound around the core 100, is able to provide a high-quality separator 12 with no or little deformation.

In order to attain the above object, a separator core in accordance with an aspect of the present invention is a separator core around which a separator for a nonaqueous electrolyte secondary battery is wound or is to be wound, including: an outer cylindrical part; an inner cylindrical part provided inside the outer cylindrical part; and support parts that are provided between the outer cylindrical part and the inner cylindrical part and that extend in radial directions to connect to the outer cylindrical part and the inner cylindrical part, the outer cylindrical part having a linearly inclined face at an edge of an outer peripheral surface thereof.

With this configuration, it is possible to efficiently obtain an outer cylindrical part that has no or little distortion at the edge thereof. Therefore, it is possible to provide a separator core that has great strength and that has no or little deformation while maintaining a surface large enough for the separator to be wound.

It should be noted that the inclined face at the edge of the outer peripheral surface of the outer cylindrical part may be changed to, for example, a curved face (such an edge may be hereinafter referred to as a “rounded edge”) in consideration of, for example, safety of operators in the production process of the separator roll, shock absorption when the core is dropped, and the like. However, in order to obtain a core that has no or little distortion at its edge by making a rounded edge, it is necessary that the rounding be larger than making a linearly inclined face. This makes it necessary to previously design a core that has a large width. In contrast, it is possible to efficiently obtain a core having no or little distortion at its edge without significantly increasing the width of the core when the outer cylindrical part has a linearly inclined face at its edge.

The separator core may be arranged such that the linearly inclined face is a chamfer. With this configuration, it is possible to more efficiently obtain a core having no or little distortion at its edge without significantly increasing the width of the core.

The separator core may be arranged such that the distance of the chamfer is 0.3 mm or longer. With this configuration, resin in the resulting edge portion contains no or little distortion.

The separator core may be arranged such that the distance of the chamfer is 2.5 mm or shorter. With this configuration, it is possible to efficiently prevent the separator from being wound on the chamfer.

The separator core may be arranged such that the distance of the chamfer is equal to or less than one third the thickness of the outer cylindrical part. With this configuration, it is possible to significantly reduce the risks of breakage and chipping.

The separator core may be arranged such that the inner cylindrical part has a linearly inclined face at an edge of an inner peripheral surface thereof. With this configuration, a shaft for rotating the separator core can be easily fitted in the inner cylindrical part.

The separator core in accordance with an aspect of the present invention may be made from a material containing an ABS resin, a polyethylene resin, a polypropylene resin, a polystyrene resin, a polyester resin, and/or a vinyl chloride resin. With this configuration, it is possible to produce a core by resin molding using a mold.

A separator roll in accordance with another aspect of the present invention is a separator roll including: the separator core described above; and a separator wound on the outer peripheral surface of the outer cylindrical part of the separator core. With this configuration, it is possible to provide a separator roll that provides a high-quality separator with no or little deformation.

The present invention is not limited to the embodiments described above, but can be variously altered within the scope of the claims.

### REFERENCE SIGNS LIST

1 Lithium-ion secondary battery

2 External device

3 Lithium ion

4 Heat-resistant layer

11 Cathode

12 Separator

12a Heat-resistant separator

13 Anode

100 Core

101 Outer cylindrical part

101A Edge

101B Edge

102 Inner cylindrical part

102A Edge

102B Edge

103 Rib

110 Separator roll

1. A separator core around which a separator for a nonaqueous electrolyte secondary battery is wound or is to be wound, comprising:
an outer cylindrical part;
an inner cylindrical part provided inside the outer cylindrical part; and
support parts that are provided between the outer cylindrical part and the inner cylindrical part and that extend in radial directions to connect to the outer cylindrical part and the inner cylindrical part,
the outer cylindrical part having a linearly inclined face at an edge of an outer peripheral surface thereof.

2. The separator core according to claim 1, wherein the linearly inclined face is a chamfer.

3. The separator core according to claim 2, wherein a distance of the chamfer is 0.3 mm or longer.

4. The separator core according to claim 3, wherein the distance of the chamfer is 2.5 mm or shorter.

5. The separator core according to claim 3, wherein the distance of the chamfer is equal to or less than one third a thickness of the outer cylindrical part.

6. The separator core according to claim 1, wherein the inner cylindrical part has a linearly inclined face at an edge of an inner peripheral surface thereof.

7. The separator core according to claim 1, which is made from a material containing an ABS resin, a polyethylene resin, a polypropylene resin, a polystyrene resin, a polyester resin, and/or a vinyl chloride resin.

8. A separator roll comprising:
the separator core as set forth in claim 1; and
a separator for a nonaqueous electrolyte secondary battery wound on the outer peripheral surface of the outer cylindrical part of the separator core.
